(19) United States
(12) Patent Application Publication
(10) Pub. No.: US 2007/0210529 A1
(43) Pub. Date: Sep. 13, 2007

(54) Radial Shaft Seal

(75) Inventors: Siegmar Kreutzer, KK Heerlen (NL); Franz Pawellek, Lautertal/ OT Oberlauter (DE)

Correspondence Address: CAHN & SAMUELS LLP, 2000 P STREET NW, SUITE 200, WASHINGTON, DC, 20036, US

(73) Assignee: VR-DICHTUNGEN GMBH, Ubach-Palenberg (DE)

(21) Appl. No.: 11/683,277

(22) Filed: Mar. 7, 2007

(30) Foreign Application Priority Data
Mar. 9, 2006 (DE) 20 2006 003 897.3

(51) Int. Cl. F16J 15/32

(52) U.S. Cl. 277/551

(57) ABSTRACT

On a radial shaft seal for sealing a closed internal space (20), filled with a fluid medium, on a rotating shaft (12) against the external atmosphere (30), comprising at least one membrane body (4) displaying a sealing membrane (8) with a sealing lip (9) that can be positioned in sealing fashion on the shaft (12) and is set obliquely to the internal space (20), where the side of the sealing membrane facing away from the internal space (20) is supported by a supporting element (3), the edge (3r) of which facing the shaft forms an annular gap with the latter, it is envisaged that at least the edge area (3r) of the supporting element (3) adjacent to the shaft (12) is made of a non-elastic plastic material, and that the width d of the annular gap (14) between the edge (3r) of the supporting element (3) and the shaft (12) is dimensioned in such a way that a pressure of 20 hPa at most can be achieved in the internal space (20) when pumping out the air from the internal space (20) against the air flowing in through the annular gap (14).

### I. FIELD OF THE INVENTION

This invention relates to a radial shaft seal for sealing a closed internal space, filled with a fluid medium, on a rotating shaft against the external atmosphere, comprising at least one membrane body displaying a sealing membrane, a sealing lip of which rests on the shaft to be sealed, particularly for use in cooling systems for motor vehicle engines. This application claims priority of German Patent Application No. 202006003897.3 filed Mar. 9, 2006, the disclosure of which is incorporated by reference in its entirety.

### II. BACKGROUND OF THE INVENTION

A radial shaft seal of this kind is known from EP-A-706 001. In this case, the sealing membrane is supported against the pressure of the fluid medium in the internal space by a supporting element that can, for example, be an axially fixed disc with a central opening, through which the shaft passes at a necessary distance from the edge of the opening. The supporting element is located on the side of the sealing membrane facing away from the internal space. The edge resting against the shaft is designed as a sealing lip set obliquely to the internal space, as a result of which the sealing effect is increased due to the internal pressure.

Another radial shaft seal of this kind is known from WO-A-02/052 180. It comprises a first membrane body with a sealing membrane, which rests on the shaft by means of a sealing lip set obliquely to the internal space and is supported by a supporting element on the outer side. A second membrane body displays a second sealing membrane, which is located a distance away in the direction of the internal space, is likewise supported by a supporting element, and rests on the shaft by means of a sealing lip angled obliquely inwards. The supporting elements are customarily made of metal, such as steel or high-grade steel. This seal has proven successful in the operation of pumps in cooling systems in which the coolant is under positive pressure, since, in the event of one sealing membrane leaking, the second still provides sufficient sealing.

However, it has nowadays become customary to evacuate the internal space down to a pressure of less than 50 hPa with a suction pump before filling the cooling system for the first time, in order to test the entire system for leaks. After reaching an internal pressure of 20 to 50 hPa, for example, filling of the system with coolant can then be started automatically in the same work step. The sealing lips of the known seals rest on the shaft under a certain pretension, and can thus also withstand negative pressure in the internal space to a certain extent. However, due to being angled inwardly, no reinforcing effect occurs in this case, and they can lift off the shaft at an internal pressure of roughly 50 hPa or less, allowing air to enter from the outside, such that the system cannot be sufficiently evacuated.

To counter this problem, WO-A-02/052 180 proposes the use of a third sealing membrane with an outwardly angled sealing lip. However, this complicates the structure of the seal, and energy losses and additional heating occur in operation.

### III. SUMMARY OF THE INVENTION

Notwithstanding the usefulness of the above-described methods, a need still exists for a simply structured radial shaft seal which makes it possible to evacuate the sealed system down to an internal pressure of less than 20 hPa without the assistance of an additional component, such as a third sealing membrane.

An objective of the invention is to fulfill this need which is solved by a radial shaft seal for sealing a closed internal space filled with a fluid medium on a rotating shaft against the external atmosphere, where the shaft seal comprises at least one membrane body displaying a sealing membrane with a sealing lip that can be positioned in sealing fashion on a shaft and is set obliquely to the internal space, where the side of the sealing membrane facing away from the internal space is supported by a supporting element, the edge of which facing the shaft forms an annular gap with the latter, characterized in that at least the edge area of the supporting element adjacent to the shaft is made of a non-elastic plastic material, and in that the width of the annular gap between the edge of the supporting element and the shaft is dimensioned in such a way that a pressure of 20 hPa at most can be achieved in the internal space when pumping out the air from the internal space against the air flowing in through the annular gap.

It has been found that, by limiting the width of the annular gap between the edge area of the supporting element lying adjacent to the shaft in the radially inward direction and the shaft itself, the quantity of air flowing through the gap following lifting of the sealing lips can be kept so small that it is substantially smaller than the quantity of air extracted by the suction pump, meaning that a vacuum of under 20 hPa can be achieved. In this context, the width of the gap is governed by the pumping capacity of the suction pump and the targeted ultimate vacuum. The gap is preferably 0.05 mm wide or narrower, particularly preferably 0.02 mm or less.

Such a narrow gap width requires a close manufacturing tolerance for the shaft and the supporting element in order to avoid contact of the two and possible damage to one part or the other. According to the invention, at least the edge area of the supporting element adjacent to the shaft is therefore made of a non-elastic plastic material. As a result, the supporting effect for the second sealing membrane is preserved, but damage to the shaft is avoided, and simpler, precise manufacture is made possible.

Preferably, the entire supporting element consists of the non-elastic plastic material.

The plastic material is preferably a thermoplastic material. A high melting point of the plastic material is advantageous. Polyphenylene sulfide (PPS) is particularly suitable.

The edge of the supporting element which borders the annular gap between the supporting element and the shaft, and is located opposite the shaft, is advantageously chamfered, e.g. on the side facing away from the sealing membrane, at an angle of roughly 45°.

In a preferred embodiment, the radial shaft seal according to the invention comprises, in addition to the at least one membrane body, a second membrane body, which displays a sealing membrane that is supported by a second supporting element and displays a sealing lip set obliquely to the internal space and resting on the shaft, where the second sealing membrane is spaced apart from the first in the direction of the internal space or towards the external atmosphere.

Advantageously, at least one of the supporting elements is designed as an angular ring, the radial leg of which supports the sealing membrane adjacent to the supporting element. The axial leg of this supporting element can then support the axial section of the membrane body.

The sealing membranes of the radial shaft seal according to the invention preferably consist of an elastomeric material containing particles of a solid lubricant that is particularly preferably graphite or polytetrafluoroethylene (PTFE).

In the embodiment with two sealing membranes, the space between the two sealing membranes is advantageously filled with a lubricant.

Given the following enabling description of the drawings, the apparatus should become evident to a person of ordinary skill in the art.

### IV. BRIEF DESCRIPTION OF THE DRAWINGS

The invention is described in more detail below, based on practical examples and appended drawings. The drawings show the following:

FIG. 1, a cross-section of an exemplary embodiment of the radial shaft seal according to the invention, with the shaft to be sealed and two sealing membranes;

FIG. 2, a cross-section of a similar seal, where the inner edge of the supporting element is chamfered;

FIG. 3, the chamfer in detail, and

FIG. 4, a partial cross-section of a radial shaft seal according to the invention, with only one membrane body.

### V. DETAILED DESCRIPTION OF THE DRAWINGS

The depicted radial shaft seal is inserted in the bearing mount 1 of a coolant pump, which forms part of the wall of the closed internal space 20. The side of the seal opposite internal space 20 communicates with the external atmosphere 30.

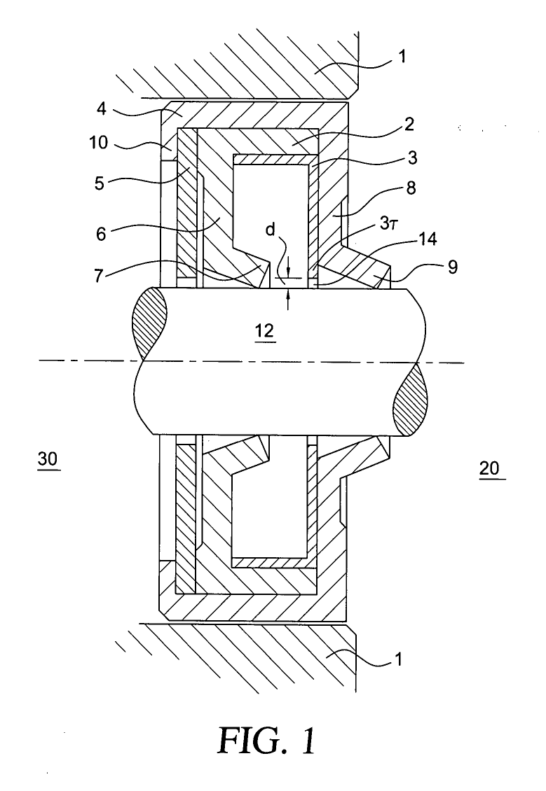

In FIG. 1, a second membrane body 2, made of an elastomeric material, is fitted on the axial leg of a second supporting element 3 in the form of an angular ring. Supporting element 3 consists of polyphenylene sulfide (PPS). Integrally molded on second membrane body 2 is a second sealing membrane 6 with a second sealing lip 7, which rests on shaft 12 in sealing fashion and is set obliquely to the internal space. A first membrane body 4 made of elastomeric material, on the pressure side of which a first sealing membrane 8 is integrally molded, with a first sealing lip 9, which is likewise set obliquely to the internal space and rests on the shaft, surrounds, on the radially outer side, second membrane body 2 with second supporting element 3, inserted in it. Placed on first membrane body 4, on the side facing external atmosphere 30, is a first supporting element 5 in the form of a disc with a hole. It is axially fixed on the outside by the radially inward-reaching edge 10 of first membrane body 4. Second supporting element 3 supports second sealing membrane 8 against pressure from internal space 20. Together with shaft 12, its radially inner edge 3r forms a gap 14 with a width d of 0.02 mm, for example. First supporting element 5 supports first sealing membrane 6 accordingly. In alternative embodiments, first supporting element 5 can also be molded from PPS and form an annular gap of 0.02 mm, for example, with the shaft, or both supporting elements 3 and 5 can be made of PPS and form an annular gap of roughly 0.02 mm with the shaft.

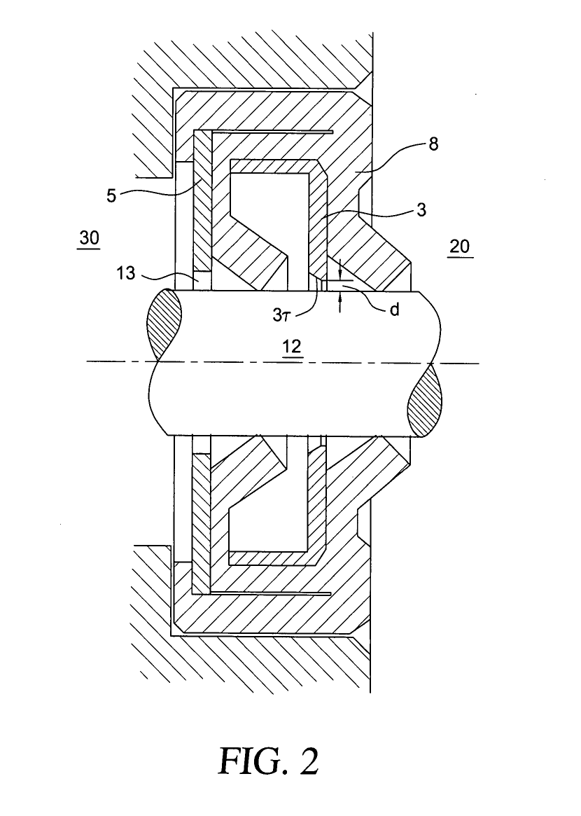

FIG. 2 shows a preferred embodiment according to the invention, where inner edge 3r of the second supporting element is chamfered at roughly 45° on the side facing away from sealing membrane 8. This embodiment offers the advantage that any contact between the shaft and inner edge 3r of supporting element 3 causes virtually no damage, whereas the effect of limiting the air flow through the annular gap is preserved completely. In this embodiment, gap 13 between the shaft and first supporting element 5 is wider than gap 14 (FIG. 1). As already mentioned, gap 13 can, however, also be provided together with gap 14, or in place of gap 14 with a width of 0.05 mm or less, if the first supporting element consists of non-elastic plastic material, e.g. PPS, at least in the inner edge area.

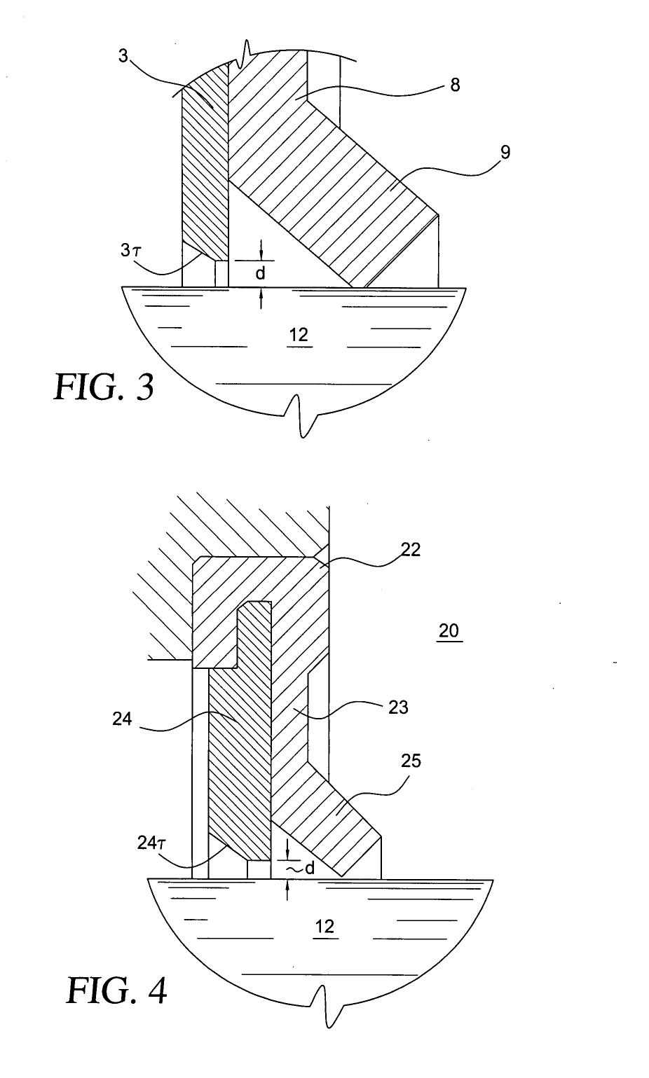

FIG. 3 shows the chamfer of inner edge 3r of supporting element 3 in detail.

FIG. 4 shows a half cross-section of a further embodiment of the radial shaft seal according to the invention with only one membrane body 22 made of elastomeric material. It displays a sealing membrane 23, whose sealing lip 25 rests on shaft 12 in sealing fashion. Supporting element 24 is designed as a stepped disc with a central opening, is axially retained by membrane body 22 and supports sealing membrane 23 against the pressure in internal space 20. On the side facing away from sealing membrane 23, inner edge 24r of supporting element 24 is chamfered at roughly 45°, forming an annular gap with a width d of roughly 0.02 mm together with shaft 12.

Using the radial shaft seal according to the invention, the leak testing and filling of a closed internal space 20 to be filled with a fluid medium, such as a cooling system for motor vehicle engines, can be performed largely automatically as follows. After assembling closed internal space 20, it is connected to a suction pump with preset suction pump flow. In this context, the pump flow must be set in such a way that it is greater than the stream of air flowing through gap 14 between supporting element 3 and shaft 12 (gap flow) as a result of the pressure difference between the external atmospheric pressure and the lowest internal pressure to be reached. The pressure difference between internal space 20 and external atmosphere 30 gradually increases at the start of the pumping operation. In this context, sealing lips 7, 9 of sealing membranes 6, 8 initially still rest tightly on shaft 12 as a result of their pretension. At this stage any deviation in the development of the internal pressure from a standard in the course of time indicates a leak in the system. When the internal pressure approaches a value dependent on the pretension of sealing lips 7, 9, e.g. roughly 50 hPa, the sealing lips are lifted off the shaft by the atmospheric pressure, and air flows into the internal space through gap 14 between shaft 12 and supporting element 3. However, since this gap flow is smaller than the pump flow, the internal pressure can continue to drop until it reaches a value, such as 20 to 50 hPa, at which a valve for automatic filling with the fluid medium, e.g. coolant, is opened by a suitable sensor-based control arrangement. The procedure can be performed in the same way with a radial shaft seal with only one membrane body.

As used herein “substantially”, “generally”, and other words of degree, are used as a relative modifier intended to indicate permissible variation from the characteristic so modified. It is not intended to be limited to the absolute value or characteristic which it modifies but rather approaching or approximating such a physical or functional characteristic.

The following is a list of reference numbers used herein:
1 Bearing mount
2 Second membrane body
3 Second supporting element
3r Edge area of the supporting element
4 First membrane body
5 First supporting element
6 Second sealing membrane
7 Second sealing lip
8 First sealing membrane
9 First sealing lip
10 Edge
12 Shaft
13 Annular gap between supporting element and shaft
14 Annular gap between supporting element and shaft
20 Internal space
22 Membrane body
23 Sealing membrane
24 Supporting element
24r Inner edge of the supporting element
30 External atmosphere
d Width of gap 14

While various aspects of the present invention have been particularly shown and described with reference to the exemplary, non-limiting, embodiments above, it will be understood by those skilled in the art that various additional aspects and embodiments may be contemplated without departing from the spirit and scope of the present invention. It would be understood that a device or method incorporating any of the additional or alternative details mentioned above would fall within the scope of the present invention as determined based upon the claims below and any equivalents thereof.

Other aspects, objects and advantages of the present invention can be obtained from a study of the drawings, the disclosure and the appended claims.

We claim:

1. Radial shaft seal for sealing a closed internal space (20), filled with a fluid medium, on a rotating shaft (12) against the external atmosphere (30), comprising at least one membrane body (4, 22) displaying a sealing membrane (8, 23) with a sealing lip (9, 25) that can be positioned in sealing fashion on a shaft (12) and is set obliquely to the internal space (20), where the side of the sealing membrane facing away from the internal space (20) is supported by a supporting element (3, 24) having an edge (3r, 24r) which facing the shaft forms an annular gap, where the edge (3r) of the supporting element (3) adjacent to the shaft (12) is made of a non-elastic plastic material, and in that the width d of an annular gap (14) between the edge (3r) of the supporting element (3, 24) and the shaft (12) is dimensioned in such a way that a pressure of 20 hPa at most can be achieved in the internal space (20) when pumping out the air from the internal space (20) against the air flowing in through the annular gap (14).

2. The radial shaft seal according to claim 1, where the annular gap (14) has a width (d) of 0.05 mm or less.

3. The radial shaft seal according to claim 1, where the gap (14) has a width (d) of 0.02 mm or less.

4. The radial shaft seal according to one of claim 1, where the supporting element (3, 24) consists entirely of non-elastic plastic material.

5. The radial shaft seal according to one of claims 4 where the plastic material of the supporting element (3, 24) is a thermoplastic material.

6. The radial shaft seal according to claim 5 where the thermoplastic material is polyphenylene sulfide (PPS).

7. The radial shaft seal according to claim 1 where the edge of the supporting element (3, 24) which borders the annular gap, and is located opposite the shaft, is chamfered.

8. The radial shaft seal according to claim 7, further comprising a second membrane body (2), which provides a sealing membrane (6) that is supported by a second supporting element (5) and provides a sealing lip (7) set obliquely to the internal space and resting on the shaft, where the second sealing membrane is spaced apart from the first in the direction of the internal space (20) or towards the external atmosphere (30), and where at least one of the first supporting element (3) and the second supporting element (5) is made of a non-elastic plastic material, and in that the width d of the annular gap (14) between the edge (3r) of the at least one non-elastic plastic supporting elements (3, 5) and the shaft (12) is dimensioned in such a way that a pressure of 20 hPa at most can be achieved in the internal space (20) when pumping out the air from the internal space (20) against the air flowing in through the annular gap (13, 14).

9. The radial shaft seal according to claim 8, where at least one of the supporting elements (3, 5, 24) is designed as an angular ring, the radial leg of which supports the sealing membrane (8, 6, 23) adjacent to the supporting element.

10. The radial shaft seal according to claim 9, where the sealing membranes (6, 8, 23) are made of an elastomeric material containing particles of a solid lubricant.

11. The radial shaft seal according to claim 10, characterized in that the particles consist of graphite or PTFE.

12. The radial shaft seal according to claim 8, characterized in that the space between the two sealing membranes (6, 8) is filled with a lubricant.

13. A radial shaft seal on a rotating shaft for sealing against the external atmosphere in a closed internal space filled with a fluid medium, comprising at least one membrane body providing a sealing membrane with a first side and a second side, and a sealing lip, said membrane body being positionable in sealing fashion about said rotating shaft, where said first side of the sealing membrane faces away from the internal space and is supported by a supporting element, said supporting element defining an edge which faces and is separated from the shaft by a select distance to establish an annular gap, where the supporting element edge adjacent to the shaft is made of a non-elastic plastic material, and in that the select distance is dimensioned in such to provide a effective seal against air flow through the annular gap and into the of internal space.

14. The radial shaft seal according to claim 13 where the annular gap defines a width of 0.05 mm or less.

15. The radial shaft seal according to claim 14 where the supporting element consists entirely of non-elastic plastic material selected from the group consisting of thermoplastics and polyphenylene sulfide (PPS).

16. The radial shaft seal according to claim 15, where the edge of the supporting element is chamfered.

17. The radial shaft seal according to claim 16 where the supporting element is an angular ring defining a radial leg that supports the sealing membrane adjacent to the supporting element.

18. The radial shaft seal according to claim 17, where the sealing membranes are composed of an elastomeric material containing particles of a solid lubricant.

19. The radial shaft seal according to claim 18, characterized in that the particles consist of graphite or PTFE.
